(19) United States
(12) Patent Application Publication
(10) Pub. No.: US 2025/0144611 A1
(43) Pub. Date: May 8, 2025

(54) PROCESS FOR OPERATING A PLANT FACILITY DURING CATALYST REGENERATION

(71) Applicant: VELOCYS TECHNOLOGIES LTD, Oxford (GB)

(72) Inventors: Soumitra R. Deshmukh, Houston, TX (US); Ivan Philip Greager, Houston, TX (US); Roger Allen Harris, Houston, TX (US); Elitsa A. Mitova, Houston, TX (US); Stephen Claude Leviness, Houston, TX (US)

(73) Assignee: VELOCYS TECHNOLOGIES LTD, Oxford (GB)

(21) Appl. No.: 18/294,974

(22) PCT Filed: Aug. 1, 2022
(86) PCT No.: PCT/EP2022/071585

§ 371 Date: Feb. 2, 2024

Related U.S. Application Data
(60) Provisional application No. 63/228,210, filed on Aug. 2, 2021.

(30) Foreign Application Priority Data
Aug. 17, 2021 (GB) 2111777.5

(51) Int. Cl. B01J 38/10

(52) U.S. Cl. CPC B01J 38/10; B01J 2231/648

(57) ABSTRACT

The present invention provides a process of conducting catalyst regeneration in a plant facility, comprising; providing a plant facility with a unit area operating within battery limits; wherein the battery limits of the unit area are configured to receive a feed material; receiving the feed material into the battery limits and flowing the feed material within the unit area of the plant facility through a plurality of parallel flow paths in a plurality of reactor trains wherein; each reactor train comprises at least one reactor; and at least one reactor in each reactor train is charged with a catalyst; isolating in at isolation step at least one, but not all, of the plurality of parallel flow paths to provide at least one isolated reactor train and remaining on-line reactor trains; regenerating in a regeneration step the catalyst in the at least one reactor in the at least one isolated reactor train; wherein during the regeneration step the feed material flows through the parallel flow paths supplied from the battery limits and accepted for processing in the plant facility is approximately constant before and during the isolation step.

The present invention relates to a process of conducting catalyst regeneration in a plant facility, for example a Fischer-Tropsch reactor or Fischer-Tropsch reactor island within a wider plant. The present invention further relates to a plant facility that conducts such process.

The Fischer-Tropsch (FT) process is widely used to generate fuels from carbon monoxide and hydrogen and can be represented by the equation:

(2n+1)H₂+nCO→CₙH₂ₙ₂+nH₂O

This reaction is highly exothermic and is catalysed by a Fischer-Tropsch catalyst, typically a cobalt-based catalyst, under conditions of elevated temperature (typically at least 180° C., e.g. 200° C. or above) and pressure (e.g. at least 10 bar). A product mixture is obtained, and n typically encompasses a range from 10 to 120. It is desirable to minimise light gas (e.g. methane) selectivity, i.e. the proportion of methane (n=1) in the product mixture, and to maximise the selectivity towards C5 and higher (n≥5) paraffins, typically to a level of 85% or higher. It is also desirable to maximise the conversion of carbon monoxide.

The hydrogen and carbon monoxide feedstock is normally synthesis gas or a gas mixture comprising synthesis gas.

The synthesis gas may be produced by gasifying a carbonaceous material at an elevated temperature, for example, about 700° C. or higher. The carbonaceous material may comprise any carbon-containing material that can be gasified to produce synthesis gas. The carbonaceous material may comprise biomass (e.g., plant or animal matter, biodegradable waste, and the like), a food resource (e.g., as corn, soybean, and the like), and/or a non-food resource such as coal (e.g., low grade coal, high grade coal, clean coal, and the like), oil (e.g., crude oil, heavy oil, tar sand oil, shale oil, and the like), solid waste (e.g., municipal solid waste, hazardous waste), refuse derived fuel (RDF), tires, petroleum coke, trash, garbage, biogas, sewage sludge, animal waste, agricultural waste (e.g., corn stover, switch grass, grass clippings), construction demolition materials, plastic materials (e.g., plastic waste), cotton gin waste, a mixture of two or more thereof, and the like.

Alternatively, synthesis gas may be produced by other means such as by reformation of natural or landfill gas, or of gases produced by anaerobic digestion processes. Also synthesis gas may be produced by CO₂ reforming using electrolysis as a hydrogen source (e.g. so called “electricity-to-fuels” processes).

The synthesis gas, produced as described above, may be treated to adjust the molar ratio of H₂ to CO by steam reforming (e.g., a steam methane reforming (SMR) reaction where methane is reacted with steam in the presence of a steam methane reforming (SMR) catalyst); partial oxidation; autothermal reforming; carbon dioxide reforming; or a combination of two or more thereof in preparation for feeding the Fischer-Tropsch catalyst (referred to as fresh synthesis gas below).

The molar ratio of H₂ to CO in the fresh synthesis gas is desirably in the range from about 1.6:1 to about 2.2:1, or from about 1.8:1 to about 2.10:1, or from about 1.95:1 to about 2.05:1.

The fresh synthesis gas may optionally be combined with a recycled tail gas (e.g. a recycled FT tail gas), which also contains H₂ and CO, to form a reactant mixture. The tail gas may optionally comprise H₂ and CO with a molar ratio of H₂ to CO in the range from about 0.5:1 to about 2:1, or from about 0.6:1 to about 1.8:1, or from about 0.7:1 to about 1.2:1.

The combined FT synthesis gas feed (comprising of fresh synthesis gas combined with recycled tailgas) desirably comprises H₂ and CO in a molar ratio in the range from about 1.4:1 to about 2.1:1, or from about 1.7:1 to about 2.0:1, or from about 1.7:1 to about 1.9:1.

When the recycled tail gas is used, the volumetric ratio of fresh synthesis gas to recycled tail gas used to form the reactant mixture may for example be in the range from about 1:1 to about 20:1, or from about 1:1 to about 10:1, or from about 1:1 to about 6:1, or from about 1:1 to about 4:1, or from about 3:2 to about 7:3, or about 2:1.

During the Fischer-Tropsch reaction, the catalyst is gradually degraded, decreasing its effectiveness and requiring a gradual increase in temperature to maintain acceptable carbon monoxide conversion.

This catalyst degradation decreases its effectiveness and requires a gradual increase in temperature to offset the activity loss and to maintain acceptable carbon monoxide conversion. This is described in Steynberg et al. “Fischer-Tropsch catalyst deactivation in commercial microchannel reactor operation” Catalysis Today 299 (2018) pp10-13.

Eventually it becomes necessary to regenerate the catalyst in order to restore its effectiveness. It is known to regenerate the catalyst in situ.

A number of different reactor types are known for carrying out Fischer-Tropsch synthesis, including fixed bed reactors, slurry bubble-column reactors (SBCR), microstructure and microchannel reactors (Rytter et al, “Deactivation and Regeneration of Commercial Type Fischer-Tropsch Co-Catalysts—A Mini-Review” Catalysts 2015, 5, pp 478-499 at pp 482-483).

Microchannel reactors are disclosed in WO 2016/201218A, in the name of the present applicant, which is incorporated by reference, and similarly in LeViness et al “Velocys Fischer-Tropsch Synthesis Technology—New Advances on State-of-the-Art” Top Catal 2014 57 pp518-525. Such reactors have the particular advantage that very effective heat removal is possible, owing to the high ratio of heat exchange surface area to microchannel (and hence catalyst) volume.

Microstructure reactors are disclosed for example in US2018207607, U.S. Pat. Nos. 8,122,909, 7,745,667.

WO 2016/201218A, in the name of the applicant, discloses a method of restarting a synthesis gas process which has stopped, in either a conventional or microchannel reactor. The process includes stopping the flow of synthesis gas into (and out of) one the reactor trains for a period of time.

A process for removing heat from an exothermic reaction, and in particular removing heat from multiple reaction trains using a common coolant system is described in US2016107962, in the name of the applicant.

In the above cited prior art, during regeneration there is a reduction in the plant facility due to a reduction in the flow rate. This results in a reduction in overall plant facility efficiency.

There therefore remains a need to provide a an improved, more environmentally friendly, optimised process for catalyst regeneration in a plant facility that maximises operational efficiency of the plant and eliminates negative impact on emissions during the catalyst regeneration period which are otherwise associated with conventional methods in the art.

The regeneration of a catalyst in situ using a heat exchange fluid such as superheated steam is disclosed in our co-pending application WO2020249529, in the name of the applicant.

The process according to the present invention is more efficient, cost effective and reduces waste, compared to conventional processes in the art because the process flow remains approximately constant and does not have to be reduced. This is advantageous over conventional processes where process flow has to be reduced in order for the plant to operate, thereby reducing plant efficiency and increased carbon emissions and increased expenditure.

The present invention is concerned with configuring a plant facility, such as a Fischer-Tropsch Island, to minimise, or obviate, the need to flare feedstock that cannot be processed and/or turndown upstream gasification unit process during the regeneration of a reactor and/or reactor train, thereby improving the overall plant efficiency and reducing carbon emissions relative to previous examples in the prior art.

The present invention is therefore concerned with a process, and a plant facility that can operate said process, whereby the regeneration of a catalyst does not detrimentally disrupt the overall production capacity of the reactor(s) and wherein the process may be easily and efficiently adapted during different operating conditions.

Conventionally, operating facilities comprising reactors that require catalyst regeneration typically flare feedstock that cannot be processed, for example synthesis gas, whilst keeping upstream units at constant capacity. However, the flaring of feedstock negatively affects the emissions profile of an operating facility, and may result in air permit violations.

Alternatively, conventional operating facilities may turn down the capacity of upstream units to facilitate catalyst regeneration, thereby reducing the amount of flaring that may be required. However, turning down upstream unit(s) of a facility undesirably reduces the facilities production capacity and compromises the efficiency of the unit operating at turndown.

Another alternative of installing spare reactors is rarely practiced owing to the capital intensive nature of this option.

There is therefore a need to obviate the flaring feedstock and/or turndown upstream units and to provide a process that utilises the full amount available synthesis gas when the plant facility is in catalyst regeneration mode.

The object of the present invention is therefore to provide a process that reduces, or eliminates, the need to flare feedstock and/or turn down the capacity of upstream units during catalyst regeneration, and thus reduce its associated negative impact on emissions and CAPEX. The present invention therefore aims to provide an improved, more environmentally friendly, optimised process for catalyst regeneration in a plant facility, for example a Fischer-Tropsch (FT) island.

A further object of the present invention is to optimise the configuration of a plant facility, for example a Fischer-Tropsch island, to enable the production of a useful product, for example synthetic fuel, to be maintained at a near constant level independent of the mode of operation, for example between normal and regeneration modes of operation. The object of the present invention therefore also concerns a process that can be performed in such facility.

According to a first aspect of the present invention, there is provided a process for operating a plant facility during catalyst regeneration, comprising;
providing a plant facility with a unit area operating within battery limits;
   wherein the battery limits of the unit area are configured to receive a feed material; receiving the feed material into the battery limits and flowing the feed material within the unit area of the plant facility through a plurality of parallel flow paths in a plurality of reactor trains wherein;
      each reactor train comprises at least one reactor;
      at least one reactor in each reactor train is charged with a catalyst;
isolating in an isolation step at least one, but not all, of the plurality of parallel flow paths to provide at least one isolated reactor train and remaining on-line reactor trains;
regenerating in a regeneration step the catalyst in at least one reactor in the at least one isolated reactor train;
wherein during the regeneration step the feed material flows through the parallel flow paths in the remaining on-line reactor trains;
wherein the volume of feed material flowing through the plurality of parallel flow paths supplied from the battery limits and accepted for processing in the plant facility is approximately constant before and during the isolation step.

The plurality of reactor trains may comprise a number of separate and distinct reactors, optionally microchannel or microstructure reactors, arranged in some configuration. The plurality of parallel flow paths may be construed to be individual reactor trains comprising a plurality of modular reactors each conducting the unit operations.

The at least one reactor may be a microstructure or microchannel reactor. Each reactor may be a microstructure or microchannel reactor.

The feed material may be a mixture. The feed material may be a gas. The feed material may be a gas mixture.

The feed material flowing through the plurality of parallel flow paths will therefore flow through the plurality of reactor trains comprising of at least one reactor in each reactor train.

The feed material may be generated by gasifying biomass and/or municipal or solid waste products and optionally subsequent reforming. Preferably, the feed material is a gas mixture. Other feedstocks such as landfill gas or natural gas may be reformed directly without prior gasification.

The inventors have found that the multi-train, modular, approach of the present invention allows the plant facility, for example an FT island when the reactors are FT reactors, to maximise operational efficiency of the plant and to eliminate negative impact on emissions during the catalyst regeneration period which are otherwise associated with conventional methods in the art. The arrangement of the present invention therefore provides a greener, more environmentally friendly process for conducting catalyst regeneration on a plant facility, whilst optimising operation to maximize production.

The approach of the present invention may be particularly helpful for small feed to liquid facilities, for example, where there is a single gasification train.

Generally, the turndown of a feed to gasification train is challenging and can pose several complexities with, for example, fluidisation of the bed material or uniformity of bed temperature.

The inventors have surprisingly found that an arrangement according to the invention, for example a multi-train configuration, allows the plant facility effectively to adapt to the changing needs of the process and operating conditions, whilst maintaining close to the design capacity for synthesis gas intake and liquid fuel production.

This can be achieved by the adjustment of operational parameters, such as recycle to feed ratio and operating temperature, in response to the changes necessary to maintain the synthesis gas processing capability during catalyst regeneration owing to the ability of the reactors to handle the increased heat load. For conventional facilities, for example where a large and/or single reactor is used per train, such an approach is either impractical or would involve a large CAPEX penalty associated with the installation of a spare train.

Conventional reactors may optionally include, for example, a fixed bed reactor, a continuous stirred tank reactor, a slurry bubble column reactor or a circulating fluidized bed reactor. The reactor according to the present invention is preferably a microstructure or microchannel reactor.

A “microchannel” is a channel having at least one internal dimension (wall-to-wall, not counting catalyst) of 10 mm or less, preferably 2 mm or less, and greater than 1 μm (preferably greater than 10 μm), and in some embodiments 50 to 500 μm; preferably a microchannel remains within these dimensions for a length of at least 10 mm, preferably at least 200 mm. In some embodiments, in the range of 50 to 1000 mm in length, and in some embodiments in the range of 100 to 600 mm. Microchannels are also defined by the presence of at least one inlet that is distinct from at least one outlet. Microchannels are not merely channels through zeolites or mesoporous materials. The length of a microchannel corresponds to the direction of flow through the microchannel. Microchannel height and width are substantially perpendicular to the direction of flow through the channel. In the case of a laminated device where a microchannel has two major surfaces (for example, surfaces formed by stacked and bonded sheets), the height is the distance from major surface to major surface and width is perpendicular to height. Microchannels may optionally be straight or substantially straight—meaning that a straight unobstructed line can be drawn through the microchannel (“unobstructed” means prior to particulate loading). Typically, devices comprise multiple microchannels that share a common header and a common footer. Although some devices have a single header and single footer; a microchannel device can have multiple headers and multiple footers.

Microchannel reactors are characterized by the presence of at least one reaction channel having at least one dimension (wall-to-wall, not counting catalyst) of 10 mm or less, preferably 2 mm or less (in some embodiments about 1 mm or less) and greater than 100 nm (preferably greater than 1 μm), and in some embodiments 50 to 500 μm. A channel containing a catalyst is a reaction channel. More generally, a reaction channel is a channel in which a reaction occurs. Microchannel apparatus is similarly characterized, except that a catalyst-containing reaction channel is not required. Both height and width are substantially perpendicular to the direction of flow of reactants through the reactor. The sides of a microchannel are defined by reaction channel walls. These walls are preferably made of a hard material such as a ceramic, an iron based alloy such as steel, or a Ni-, Co- or Fe-based superalloy such as monel. The choice of material for the walls of the reaction channel may depend on the reaction for which the reactor is intended. The reaction chamber walls may optionally be comprised of a stainless steel or Inconel™ which is durable and has good thermal conductivity. Typically, reaction channel walls are formed of the material that provides the primary structural support for the microchannel apparatus. The microchannel apparatus can be made by known methods, and may optionally be made by laminating interleaved plates (also known as “shims”), and preferably where shims designed for reaction channels are interleaved with shims designed for heat exchange. Some microchannel apparatus include at least 10 layers (or at least 100 layers) laminated in a device, where each of these layers contain at least 10 channels (or at least 100 channels); the device may optionally contain other layers with fewer channels.

Microstructure reactors may be similarly characterised with reference to the degree of confinement in which a chemical reaction takes place and are characterized by the presence of at least one reaction zone having at least one dimension (wall-to-wall, not counting catalyst) of 10 mm or less. A zone containing a catalyst is a reaction zone. More generally, a reaction zone is a zone in which a reaction occurs. Microstructure apparatus is similarly characterized, except that a catalyst-containing reaction zone is not required.

Therefore, a “microstructure” reactor is be construed as a confined space reactor in which a chemical reaction takes place in a reaction zone having at least one dimension (wall-to-wall, not counting catalyst) of 10 mm or less. Microstructure reactors may be similarly characterised to microchannel reactors.

In the description that follows the terms “microchannel reactor” and “microchannel” are used for illustrative and descriptive purposes but it should be understood that microstructure reactors are also specifically within the scope of the invention.

The invention therefore provides a process which is flexibly responsive to operational factors, and also affords a more environmentally beneficial process, without adversely affecting production capacity. The flexibility of the process allows the process according to the present invention to be more reliable and optimize feed ratios when compared to processes in the art.

The feed material may optionally comprise hydrogen and carbon monoxide. Preferably, the feed material is or comprises synthesis gas.

The term synthesis gas is to be construed to mean a gas primarily comprising hydrogen and carbon monoxide. Other components such as carbon dioxide, nitrogen, argon, water, methane, tars, acid gases, higher molecular weight hydrocarbons, oils, volatile metals, char, phosphorus, halides and ash may also be present. The concentration of contaminants and impurities present will be dependent on the stage of the process and carbonaceous feedstock source. It is to be understood that carbonaceous material, for example, CH₄ and inert gas such as N₂ present in the raw synthesis gas generated is expected to be carried forth through each of the subsequent steps and may not be explicitly mentioned.

The synthesis gas may optionally be generated by gasifying biomass and/or municipal or solid waste products and optionally subsequent reforming. Other feedstocks such as landfill gas or natural gas may be reformed directly without prior gasification.

In the microchannel reactors, the catalyst may be regenerated in situ, as is disclosed in our co-pending application WO2020249529.

The unit area operates within battery limits. The battery limits of the unit area in accordance with the present invention are configured to receive feed material. The feed material received may be used for processing and supplying products for downstream processing. The unit area may for example be a Fischer-Tropsch area or a Fischer-Tropsch Island. The downstream processes may for example be heavy FT liquid (HFTL) and light FT liquid (LFTL) liquid hydrocarbon products for upgrading and/or storage.

The number of reactor trains in the unit area, for example an FT island, may optionally be at least two, at least three, at least four, or at least five. In one embodiment there are two reactor trains in the unit area. In an alternative embodiment, there are three reactor trains in the unit area.

The number of reactors, for example microchannel reactors, in each reactor train may optionally be at least one, at least two, at least three, at least four, or at least five. In one embodiment, there are two reactors in each reactor train. In another embodiment, there are three reactors in each reactor train.

The number of reactors present in each reactor train within the unit area may be the same or different.

The term reactor train in accordance with the invention may be construed to be a set of parallel reactors, for example parallel microchannel reactors.

The reactor size and configuration will be tailored based on the total number of reactors to be selected for the feed processing (number of reactor trains x number of microchannel reactors in each train) so as to maximize the overall production at a reasonable capital investment.

According to this inventive approach, increasing the number of reactor trains (each with a minimum of 1 reactor) to more than one increases the availability and the ability of the unit area, for example an FT area, to process all available syngas at all times and therefore results in an increased the production from the facility. On the other hand, the higher number of reactor trains will increase the cost in terms of requiring a higher number of (smaller sized) equipment but will reduce the cost associated with the regeneration equipment which will also be better utilized. Depending on the amount of feed material to be processed in the unit area within the plant facility, there will be an optimum number of reactor trains, and number of reactors per reactor train, to ensure the maximal uptake of the feed material and to ensure optimised product yield.

The reactors (deployed as at least one in each reactor train) installed in a plurality of reactor trains may be suitable for highly exothermic and/or highly endothermic reactions, for example Fischer-Tropsch synthesis and methanol synthesis.

In one embodiment, the reactor, for example microchannel reactor, (deployed as at least one in a reactor train) may be at least one Fischer-Tropsch reactor. The Fischer-Tropsch reactor may be a Fischer-Tropsch microchannel reactor. The parallel flow paths may flow through multiple channels of one or more Fisher-Tropsch reactors.

The plant facility may be a XTL (feed to liquid) facility. The XTL facility may for example be a waste to liquids facility, a biomass to liquids facility, a gas to liquids facility and/or an electricity to fuel facility. The unit area may be construed to be a synthesis unit. The unit area may, for example, be a Fischer-Tropsch area or a Fischer-Tropsch Island. The Fischer-Tropsch area or Fischer-Tropsch Island may take in synthesis gas and provide hydrocarbon products, for example.

According to the embodiment relating to Fischer-Tropsch synthesis, the feed material (for example, synthesis gas comprising carbon monoxide and hydrogen), is fed into a Fischer-Tropsch reactor, preferably a Fischer-Tropsch microchannel reactor. The Fischer-Tropsch reactor may convert at least part of the carbon monoxide and hydrogen of the feed material into mainly linear hydrocarbons.

The conversion of synthesis gas into liquid hydrocarbons is in the presence of a catalyst. The chain length distribution will be dependent on the properties of the catalyst used and operating conditions.

Fischer-Tropsch reactions are highly exothermic and release heat that must be removed to keep the temperature of the reaction approximately constant. Localised high temperatures in the catalyst bed have been found to adversely affect the FT catalyst and the product make. Therefore, heat must be efficiently transferred to maintain an optimal and uniform temperature, so as to achieve the highest catalyst activity and longest catalyst life.

One way in which the temperature may be set is by varying the pressure of a steam drum associated with the FT reactor used in conjunction with circulating cooling water. The circulating cooling water helps to control the temperature rise from the heat generated during the reaction.

A Fischer-Tropsch Island (FT Island) is a form of FT reactor wherein the reactor has multiple different reactor trains fed from the same common feedstock reservoir, where each reactor train comprises one or more microchannel reactors.

The operating temperature for the FT synthesis may be between about 125 and 350° C., between about 150 and 300° C., between about 170 and 250° C., between about 180 and 240° C. Preferably, the operating temperature is between about 180 and 240° C. for a low temperature FT technology.

The products that may be obtained in the FT synthesis, for example, said hydrocarbons, may include heavy FT liquid (HFTL), light FT liquid (LFTL), FT process water, naphtha, and tail gas comprising of inerts as well as uncondensed light hydrocarbons, typically C1 to C4. A part of the tail gas comprising of light hydrocarbons, C1 to C4 range, may be recycled.

At least one reactor in each reactor train comprises a catalyst. The at least one reactor is charged with a catalyst. Each reactor may comprise a catalyst.

The catalyst may for example be a metal or compounded metal catalyst with a support. Preferably the catalyst is a metal-based catalyst, for example a Fischer-Tropsch catalyst, such as a cobalt or iron-containing catalyst. The Fischer-Tropsch catalyst may have any size and geometric configuration that fits within the process microchannels.

Preferably the catalyst is disposed on a porous support. The support may be made from silica and/or titania for example.

The catalyst may optionally be in the form of particulate solids (e.g., pellets, powder, fibers, and the like) having a median particle diameter of about 1 to about 1000 μm (microns), or about 10 to about 750 μm, or about 25 to about 500 μm. The median particle diameter may optionally be in the range from 50 to about 500 μm or about 100 to about 500 μm, or about 125 to about 400 μm, or about 170 to about 300 μm. In one embodiment, the catalyst may be in the form of a fixed bed of particulate solids.

Eventually, it will become necessary to regenerate the catalyst in order to restore its effectiveness.

During catalyst regeneration, the process of the present invention isolates in an isolation step, the reactor train comprising the reactor comprising the catalyst required to be regenerated, from the rest of the facility. As a result, at least one reactor train, comprising a number of reactors, becomes isolated or “offline” during catalyst regeneration.

The at least one isolated reactor train may optionally be offline for a period from about 3 days to about 14 days, or from about 4 days to about 12 days, or from about 5 days to about 10 days. The at least one isolated reactor train may optionally be offline for a period of about 7 days.

As the catalyst regeneration can take several days, and thus the corresponding microchannel reactor is offline for a prolonged period of time, it is essential for the plant facility to be able to operate at full or near-full capacity, to minimise any reduction in product yield.

The at least one isolated microchannel reactor therefore may undergo regeneration of the catalyst in situ, for example as disclosed in our co-pending application WO2020249529.

The modular nature of the plant facility according to the present invention advantageously provides a superior configuration for catalyst regeneration compared to conventional plant facilities. The modular nature provides the facility availability of the present invention to have the potential to isolate the reactor train with the reactor(s) that require catalyst regeneration whilst the remaining on-line reactor trains remain largely unaffected and take up the additional processing burden by adjustment of operating conditions, thereby increasing the flexibility and reliability of the overall process.

Conventional reactors are not of a modular nature, and to modularise conventional facilities would be complicated. Therefore, it is expected that for the isolation of each reactor train there is a projected linear decrease in synthesis gas conversion or a linear decrease in the upstream syngas production and thus a decrease in overall production capability.

For example, where two reactor trains are online in normal operation, during catalyst regeneration there will only be one remaining reactor train that is on-line. As a result, the skilled person would expect the resulting production capability and synthesis gas conversion to reduce to a 50% capacity. As a further non-limiting example, where four reactor trains are online in normal operation, typically only three reactor trains are online during catalyst regeneration. In this situation, the skilled person would expect to lose a quarter (25%) of production capability/synthesis gas conversion.

To compensate for this loss in production capacity, conventional facilities may comprise an entire separate reactor train to be deployed only during the regeneration, which is very costly, or system shutdown to accommodate changes in operation conditions and to handle the incoming gas mixture feed.

The inventors have surprisingly found that the use of microchannels and/or a multi-train approach provides a process that enables regeneration of a catalyst without affecting the overall production capability of the facility and provides a process that does not require the installation of external operational facilities to adjust to the change in operating conditions.

The isolating of at least one of the plurality of parallel flow paths, and therefore the isolation of at least one reactor train, restricts the flow of the feed material through said isolated parallel flow path. As a result, the feed material that would have flowed through said flow path instead flows through the remaining un-isolated flow paths, in addition to the feed material that would have already otherwise been flowing through said path. The feed material flowing through the plurality of parallel flow paths before and during the isolation step is therefore approximately constant.

The feed material may be received from the upstream feed gas production unit. The upstream feed gas production unit may for example be a gasification unit.

The feed material being approximately constant before and during the isolation step may be independent of the number of reactor trains and reactors, optionally microchannel reactors, that are on-line.

By the term “approximately constant” we mean that the volume of feed material (received from the upstream feed gas production unit) flowing through the plurality of parallel flow paths before and during the isolation step does not vary by more than 10%, preferably by no more than 7%, more preferably by no more than 5%.

As a result of the feed material (received from the upstream feed gas production unit) between different operational modes being approximately constant, the production can therefore be maintained at a near constant level, independent of the mode of operation.

The term “constant level” is to be construed as the difference in production between normal and regeneration modes being less than 10%, less than 7%, less than 5%.

The process according to the present invention therefore always ensures maximum utilisation of the processing capacity of the plant facility, for example, both under normal operation and during catalyst regeneration. The process therefore enhances overall plant efficiency and maximises conversion of feedstock to useful product, reducing emissions and lowering expenditure.

In the event of an unforeseen mechanical issue with one train in the arrangement, the approach according to the present invention advantageously allows the flexibility to continue processing all of the available feedstock or feed material, thereby making the plant facility more reliable.

It has been found that the process of the invention obviates or reduces the need to flare the feedstock or turndown capacity of upstream units during gasification. The desired catalyst regeneration process may be achieved without the requirement of flaring or turndown, as is conventionally used.

Accordingly, the process according to the present invention may not include flaring of the feedstock and/or turn down of upstream units.

By the term “upstream units” we mean the units that precede the FT reactor (FT Island) in the plant facility. These upstream units may for example include the gasification island, a water-gas shift reactor, and other units used to prepare and purify a synthesis gas prior to entry into the catalyst containing process channels where the synthesis gas is converted into useful product.

In conventional processes, during catalyst regeneration phases when one or more reaction trains are not in use, and process capacity is lowered, it is sometimes necessary to reduce the amount of synthesis gas provided to the process channels containing the catalyst. This can be achieved by either; flaring feedstock, wherein excess feedstock gas is released from the system and burned, or by turning down upstream units, wherein units that produce the synthesis gas, for example the gasification island, are effectively switched off to stop or reduce the amount of feedstock gas provided to the process channels. Neither of these processes are environmentally friendly, and contribute to a significant fall in plant efficiency.

The process according to the invention therefore provides an economic advantage compared to conventional processes of the art. For example, the production is maintained through adjustment of operational parameters, such as recycle to feed ratio and operating temperature, in response to feed material, optionally a gas mixture, (for example, synthesis gas) availability during catalyst regeneration compared to a conventional facility where a turndown would be required, thereby resulting in a production loss.

As a result of the volume of feed material (received from the upstream feed gas production unit) flowing through the plurality of parallel flow paths before and during the isolation step being approximately constant, it is important that the unit area can handle the surplus feed material (resulting from the isolation of a flow path) without damaging the unit area apparatus or causing dangerous runaway reactions. This is particularly important where highly exothermic reactions are taking place in the reactors.

For example, where the modular reactors are Fischer-Tropsch reactors, preferably Fischer-Tropsch microchannel reactors, and the feed material is synthesis gas, the surplus in synthesis gas available for flowing through the remaining online reactors during catalyst regeneration will lead to an increased heat release in the reactors as the feed material converted in the unit area is kept constant.

The ability to handle the increase in synthesis gas feed volume per reactor train (and therefore per microchannel reactor) and consequent increase in heat load is due to the implementation of microchannel reactors in the process of the present invention. Microchannel reactors have enhanced heat and mass transfer capabilities compared to conventional reactors. Therefore, the use of microchannels in accordance with the invention minimises the risk of uncontrolled exothermic reactions, thermal runaway reactions and the undesirable high production of methane.

The temperature of the gas stream may optionally be controlled by heat exchange fluid flowing through the heat exchange channels of the reactor, preferably microchannel reactor. Preferably, the heat exchange fluid is circulating cooling water.

When operating a conventional facility, for example with a conventional tubular reactor, the skilled person would not expect such configuration to be able to handle an increased heat load (resulting from increase in heat generation from the additional feed gas processed during catalyst regeneration). Instead, in conventional facilities, the increase in synthesis gas conversion and higher heat release would be considered dangerous, due to the likelihood of uncontrollable runaway reactions resulting from the increased temperatures due to ineffective heat removal. Thus, conventional reactors would not be able to safely accommodate the change in operating conditions proposed in the inventive process.

One approach to this problem in conventional facilities has been to limit the volumetric productivity such that the rate at which heat is removed can keep appropriate pace with the rate at which heat is produced. This is the principle behind the conventional fixed-bed reactor, which is commonly used in the art. Additionally, in order to accommodate the change in conditions during catalyst regeneration, these conventional reactors typically involve flaring of the feedstock, turndown of upstream gasification systems or the installations of entire separate trains, all of which are costly and undesirable.

Alternatively, by using a reactor design in which heat can be more effectively removed, such as in a microchannel reactor, it is possible to increase the volumetric productivity while still maintaining the local reaction temperature within a few degrees of a process target value. This allows for the flexibility in utilizing the subset of installed reactors with production rates sufficiently high to achieve economic targets.

The inventors of the present invention have found that such process, and configuration, provides dynamic flexibility during catalyst regeneration.

The process according to the present invention therefore has the ability to accommodate all available and/or produced synthesis gas with a flexibility of processing with or without internal recycle. The process of the invention therefore has the ability to handle the dynamics of the transition between internal recycle (i.e. with tailgas recycle) and no internal recycle as the fresh syngas processing load fluctuates in the process for regeneration of the catalyst.

The modular approach of the present invention helps to minimise downtime due to the isolation of reactor trains (each comprising at least one reactor comprising a catalyst) when individual modules of microchannel reactors requiring their catalysts to be regenerated. In contrast, conventional fixed bed systems require an entire spare separate train or system shutdown or turndowns to accommodate changes or repairs to their reactors.

As a result, in the case of expected (for example catalyst regeneration) or unexpected (for example, a trip in the facility) operational interruptions, the process according to the present invention allows for continuous operation and therefore may not be detrimentally affected by expected or unexpected interruptions.

Preferably, the process is a continuous process where a feed material (for example synthesis gas), of whatever nature, is continuously fed to the plant facility (for example, a Fischer-Tropsch island) through a plurality of parallel flow paths.

After regeneration of the catalyst is complete, the process according to the present invention adapts efficiently and flexibly to resume flowing of the feed material though the previously isolated flow path. The isolated reactor train may be integrated back into the plant facility.

For the avoidance of doubt, all features relating to the process of conducting catalyst regeneration may optionally apply, where appropriate, to the plant facility for conducing catalyst regeneration, and vice versa.

### EXAMPLES

Fresh synthesis gas was obtained from an upstream gasification island (see examples for specific fresh synthesis gas rate) and was supplied to a Fischer-Tropsch area comprising a plurality of reactor trains each comprising of at least one microchannel reactor. Multiple configurations of installed microchannel reactors were considered to assess its impact on the processing capability of the available syngas and the overall production from the facility.

Example 1 and Table 1 considers the installation of 1 microchannel reactor per reactor train and shows the impact on the overall facility production between normal operation and the case when 1 of the installed trains is in regeneration (regeneration mode).

Example 2 and Table 2 considers the installation of 2 microchannel reactors per reactor train and shows the impact on the overall facility production between normal operation and the case when 1 of the installed trains is in regeneration (regeneration mode).

Example 2 and Table 3 provides a similar assessment for the option of installing 3 microchannel reactors per reactor train.

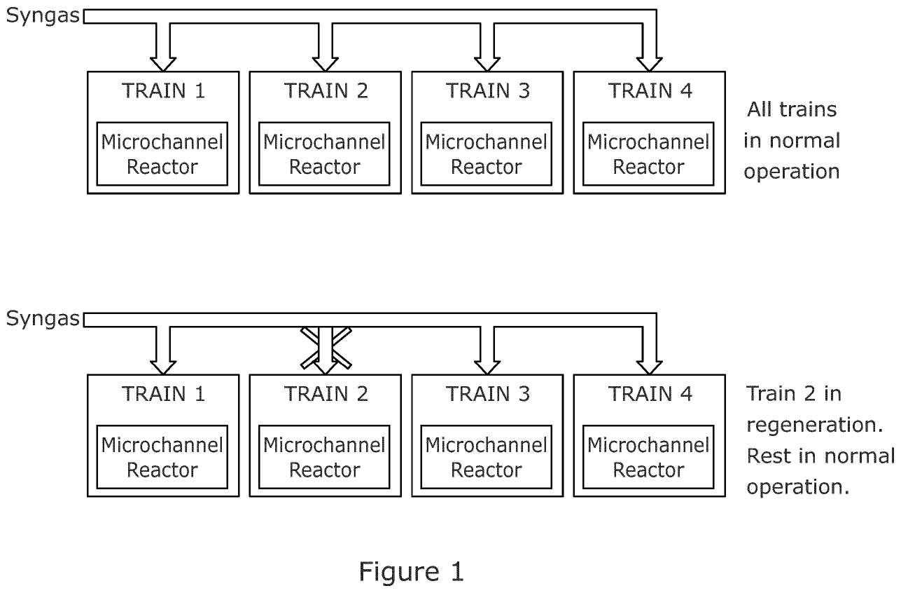

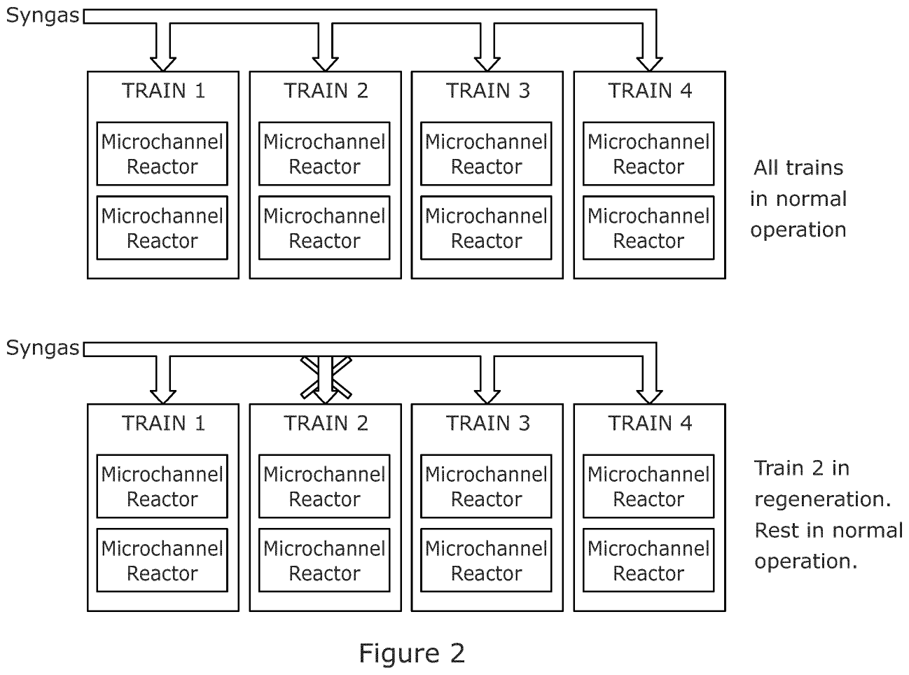

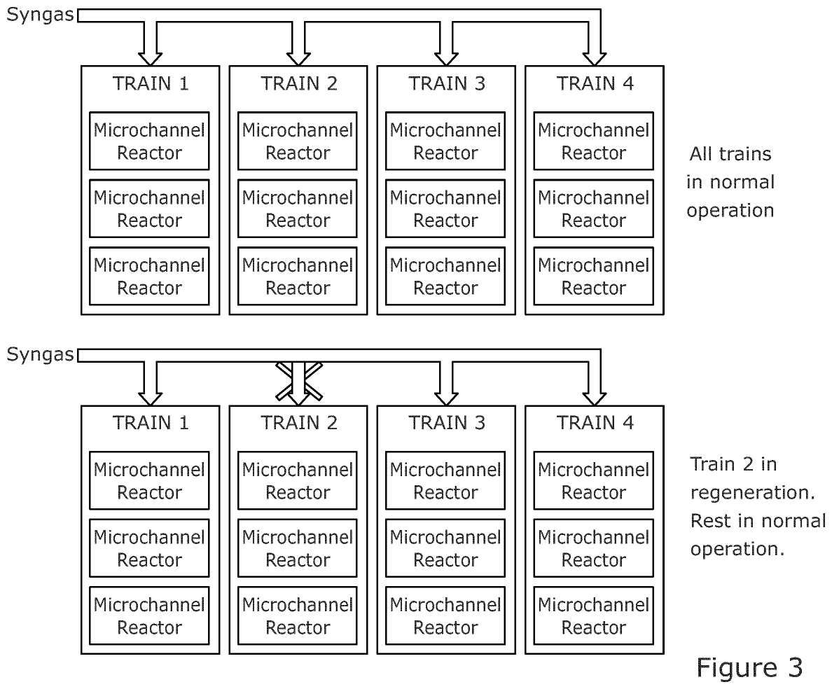

The facility setup for the configurations represented by the maximum number of trains illustrated in Tables 1 to 3 are shown in FIGS. 1 to 3 respectively.

It will be apparent that whereas in these examples Train 2 is depicted as the single isolated train during regeneration, other Trains may instead (or as well) be isolated during regeneration; and that configurations of numbers of reactor trains, number of reactors per train, and the location and/or quantity of reactors and/or reactor trains being isolated during regeneration may be varied in accordance with this invention.

The quantity of synthesis gas feed assumed in Example 2 is approximately 5 times the feed of Example 1. It would therefore be clear to the skilled person that additional reactors and/or reactor trains will be necessary to process this increase in feed gas quantity. Therefore, a configuration with a disproportionally small number of reactor trains (for example, with two reactors) are not presented in Tables 2 and 3 of Example 2.

For the purposes of data reported in Tables 1 to 3, a periodic regeneration of each reactor train every 60 days is considered to reverse any effects of reversible poisoning for example, from reactive nitrogen species and those from normal deactivation mechanisms such as non-reactive carbon accumulation and mild oxidation. The reported production numbers are based on the average operating temperature for the reactor trains over a 2-year period.

During catalyst regeneration all microchannel reactors in the 1 reactor train (where catalyst regeneration is taking place) are assumed to be taken offline for a period of 7 days.

During regeneration, the catalyst undergoes a regeneration process comprising of wax removal, oxidation and reduction steps (WROR) and requires heat-up and cool-down of the catalyst bed, in a reactor, in each step.

In preparation for regeneration the synthesis gas is stopped in the offline reactor by lowering the temperature to approximately 170° C. and then the synthesis gas is cut off, resulting in an isolated reactor train. Once the reactor train scheduled for regeneration has been successfully isolated, it is ready for regeneration. The isolated reactor train is purged with hydrogen to establish the environment for wax removal step before initiating the heat up. Upon completion of the required high temperature holds, the reactor train is cooled to an appropriate transition temperature for the oxidation step. In the oxidation step, the reactors in the train are purged with nitrogen and the target level of oxygen is gradually established and heat up initiated. Upon completion of the required high temperature hold, the reactor train is cooled to an appropriate transition temperature for the reduction step. In the reduction step, the reactors in the train are purged with nitrogen and the target hydrogen environment is established and heat up initiated. Upon completion of the required high temperature hold, the reactor train is cooled to an appropriate transition temperature for the syngas re-introduction step.

Upon completion of the regeneration steps, the flow of synthesis gas is re-started and the isolated reactor train is integrated back into the plant facility.

The term “turndown” when used throughout the examples is to be construed as the theoretical expected turndown, for example, the results that the skilled person would expect of a conventional reactor.

The term “actual” when used throughout the examples is to be construed as the actual difference in production between catalyst regeneration mode (where one reactor train is offline) and normal operational mode, when a process and/or plant facility according to the present invention is employed.

The term production delta during regen is to be construed as a measure of the loss in production estimated as a difference in production levels in normal operation and when one train is in regeneration relative to the production levels in normal operation.

### Example 1

Fresh synthesis gas was obtained from an upstream gasification island at the rate of 460 kmol/hr (with a H2:CO molar ratio of 2.00 and approximately 8 mol % inerts) and was supplied to a Fischer-Tropsch area comprising a plurality of reactor trains each comprising of at least one microchannel reactor. The rest of the process is as described above.

Table 1 shows the outcomes of installing 1 to 4 reactor trains (each with 1 microchannel reactor) in the unit area for processing the available syngas feed. In all the cases, except the case of 1 reactor train of 1 microchannel reactor, the unit area is able to accept 100% of the available fresh syngas feed during both normal operation and regeneration modes.

TABLE 1
Configuration 1: One microchannel Fischer-Tropsch reactor per reactor train

| | Turndown | Actual | Turndown | Actual | Turndown | Actual | Turndown | Actual |
|---|---|---|---|---|---|---|---|---|
| | 100.0% | N/A | 50.0% | 24.8% | 33.3% | 2.3% | 25.0% | 0.6% |
| Production delta during Regen | Normal | Regen | Normal | Regen | Normal | Regen | Normal | Regen |
| Number of reactor trains online | 1 | 0 | 2 | 1 | 3 | 2 | 4 | 3 |
| Per-pass conversion | 70.0% | 0.0% | 70.0% | 70.0% | 70.0% | 70.0% | 70.0% | 70.0% |
| Overall conversion | 70% | 0.0% | 90.2% | 70.0% | 91.9% | 90.9% | 92.7% | 92.2% |
| R/F (internal recycle/fresh feed molar | 0.0 | 0.00 | 0.50 | 0.00 | 0.59 | 0.53 | 0.64 | 0.61 |
| ratio) | | | | | | | | |
| Total liquids, BPD | 224 | 0 | 298 | 224 | 310 | 303 | 314 | 312 |

| | | | | |
|---|---|---|---|---|
| Time average, BPD | 200 | 282 | 308 | 313 |

In the case where there is only 1 reactor train of 1 microchannel reactor when 1 reactor train is taken offline for regeneration there are no available reactor trains to accept synthesis gas. Consequently, the upstream units would have to be shut down or 100% of the gas would have to be flared. The case of one reactor train of 1 microchannel reactor is therefore not an embodiment of the present invention.

In the case of 2 reactor trains of 1 microchannel reactor each, when 1 reactor train is taken offline for regeneration, the expected turndown for a conventional facility is ½ or 50%. In a conventional facility, for example a fixed bed reactor or a slurry bubble column reactor, catalyst regeneration would typically involve the turndown of upstream units to reduce the intake of available synthesis gas. This is required in conventional facilities to control the increase in temperature that would otherwise occur due to the added reaction heat load and potentially lead to unstable operation and poor product selectivity. Advantageously, the modular nature of the reactor configuration according to the present invention allows flexibility in design to maximise the utilisation of the synthesis gas available from upstream units. Therefore, when using the approach of the present invention, additional feed available is accepted by the remaining 1 (out of 2 installed) trains online (owing to the enhanced heat removal capacities of the microchannel reactor) and the actual reduction in production is only found to be approximately 25%.

Furthermore, as the third train is added, the production delta during regeneration decreases to about 2% owing to the ability to maintain increased production levels using the approach according to the invention compared to the turndown expectations. Further adding the fourth train reduces the production delta during regeneration to less than 1% but offers marginal improvement in the time-averaged production thereby reducing the value of the investment required. In practice, while it is possible to maintain the production at or near constant level irrespective of the mode of operation (for example, less than 1% production delta during regeneration), a less than 10% or less than 5% production difference based on the ability to process 100% of the available syngas would likely be acceptable.

### Example 2

Fresh synthesis gas obtained from an upstream gasification island at the rate of 2236 kmol/hr (with a H2:CO molar ratio of 2.00 and approximately 8 mol % inerts) was supplied to a Fischer-Tropsch area comprising a plurality of reactor trains each comprising of a plurality of microchannel reactors. The rest of the process is as described above.

Table 2 shows the outcomes of installing 3 to 6 reactor trains (each with 2 microchannel reactors) while processing the said quantity of syngas feed. The arrangement of 3 or more installed reactor trains (each with 2 microchannel reactors) is able to accept 100% of the available fresh syngas load during normal operation and the regeneration modes.

Table 3 shows the outcomes of installing 3 to 5 reactor trains (each with 3 microchannel reactors) while processing the same quantity of syngas feed as exemplified in Table 2. In this instance as well, the arrangement of 3 or more installed reactor trains (each with 3 microchannel reactors) is able to accept 100% of the available fresh syngas load during normal operation and in regeneration mode. The inclusion of an extra microchannel reactor in each reactor train (compared to the case represented in Table 2 where there are 2 installed reactors per train) reduces the production delta during regen, as shown in Table 3.

In the case of 4 reactor trains of 2 microchannel reactors each, when 1 reactor train is taken offline for regeneration, the expected turndown for a conventional facility is ¼ or 25%. In a conventional facility, for example a fixed bed reactor or a slurry bubble column reactor, catalyst regeneration would typically involve the turndown of upstream units to reduce the intake of available synthesis gas. This is required in conventional facilities to control the increase in temperature that would otherwise occur due to the added reaction heat load and potentially lead to unstable operation and poor product selectivity. Advantageously, the modular nature of the reactor configuration according to the present invention allows flexibility in design to maximise the utilisation of the synthesis gas available from upstream units. Therefore, when using the approach of the present invention, additional feed available is accepted by the remaining 3 (out of 4 installed) trains online (owing to the enhanced heat removal capacities of the microchannel reactor) and the actual reduction in production is only found to be ˜7%.

Furthermore, as the number of reactor trains is increased, the production delta during regen decreases owing to the ability to maintain increased production levels using the approach according to the invention compared to the turndown expectations.

While it is possible to maintain the production at a near constant level irrespective of the mode of operation (for example, less than 1% production delta during regen), a less than 10% or less than 5% production difference based on the ability to process 100% of the available syngas may be acceptable in practice.

TABLE 2
Configuration 2: Two microchannel Fischer-Tropsch reactors per reactor train

| | Turndown | Actual | Turndown | Actual | Turndown | Actual | Turndown | Actual |
|---|---|---|---|---|---|---|---|---|
| | 33% | 16% | 25% | 7% | 20% | 4% | 17% | 1% |
| Production delta during Regen | Normal | Regen | Normal | Regen | Normal | Regen | Normal | Regen |
| Number of reactor trains online | 3 | 2 | 4 | 3 | 5 | 4 | 6 | 5 |
| Per-pass conversion | 70.0% | 70.0% | 70.0% | 70.0% | 70.0% | 70.0% | 70.0% | 70.0% |
| Overall conversion | 82.5% | 70.0% | 87.7% | 82.5% | 90.4% | 88.0% | 91.4% | 90.7% |
| R/F (internal recycle/fresh | 0.25 | 0.00 | 0.40 | 0.25 | 0.51 | 0.41 | 0.56 | 0.52 |
| feed molar ratio) | | | | | | | | |
| Total liquids, BPD | 1265 | 1059 | 1386 | 1288 | 1456 | 1402 | 1489 | 1469 |

| | | | | |
|---|---|---|---|---|
| Time average, BPD | 1200 | 1345 | 1428 | 1476 |

TABLE 3
Configuration 3: Three microchannel Fischer-Tropsch reactors per reactor train

| | Turndown | Actual | Turndown | Actual | Turndown | Actual |
|---|---|---|---|---|---|---|
| | 33% | 9% | 25% | 3% | 20% | 2% |
| Production delta during Regen | Normal | Regen | Normal | Regen | Normal | Regen |
| Number of trains online | 3 | 2 | 4 | 3 | 5 | 4 |
| Per-pass conversion | 70.0% | 70.0% | 70.0% | 70.0% | 70.0% | 70.0% |
| Overall conversion | 89.4% | 82.6% | 91.4% | 89.5% | 92.2% | 91.4% |
| R/F (internal recycle/fresh | 0.47 | 0.25 | 0.56 | 0.47 | 0.61 | 0.56 |
| feed molar ratio) | | | | | | |
| Total liquids, BPD | 1428 | 1294 | 1491 | 1440 | 1517 | 1494 |

| | | | |
|---|---|---|---|
| Time average, BPD | 1386 | 1469 | 1505 |

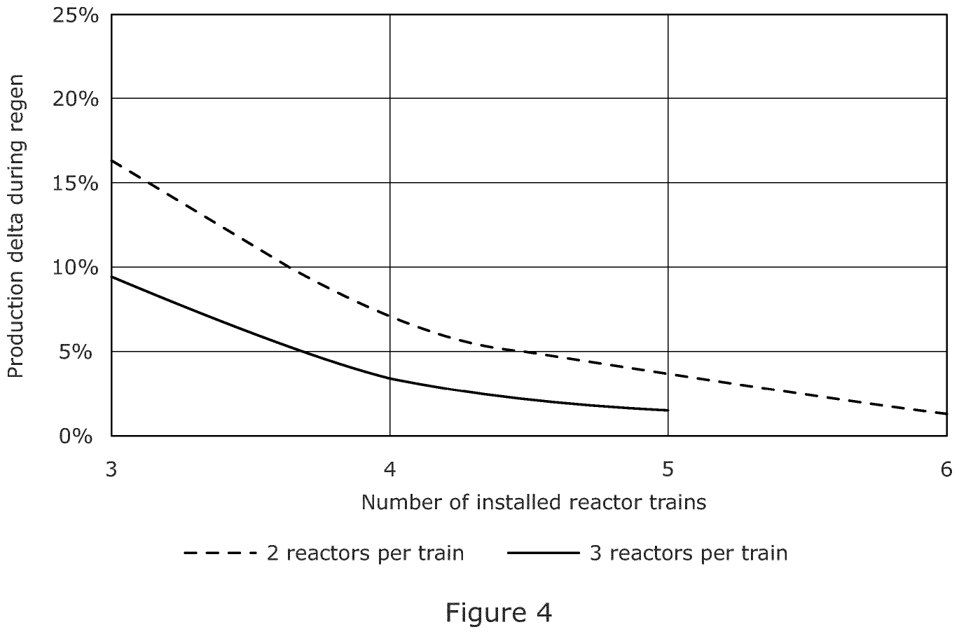

As can be seen when comparing Tables 2 and 3, the production delta during regen (i.e. difference in production between the normal and regeneration operational mode) decreases more rapidly as the number of microchannel reactors per reactor train increases. Additionally, as the number of reactor trains increases, the production delta during regens decreases owing to the ability to maintain increased production levels with an arrangement according to the present invention. This is exemplified in FIG. 4.

The longer the duration and higher the frequency of the regeneration process, the more relevant are the advantages of process according to the invention. Typically, as the catalyst deactivates, the reactor operating temperature is increased to maintain the conversion. A consequence of higher operating temperatures is a decrease in the favourable product make. Since regeneration can improve the activity of the catalyst and reverse the impact of deactivation, a high regeneration frequency may be desirable to maintain the catalyst in a higher activity state to maximize the production of favourable products. In these instances, the ability to maintain the production at target rates independent of the state of the catalyst is beneficial to maximize the value of the products from the facility.

1. A process for operating a plant facility during catalyst regeneration, comprising;
providing a plant facility with a unit area operating within battery limits;
wherein the battery limits of the unit area are configured to receive a feed material;
receiving the feed material into the battery limits and flowing the feed material within the unit area of the plant facility through a plurality of parallel flow paths in a plurality of reactor trains wherein;
each reactor train comprises at least one reactor; and
at least one reactor in each reactor train is charged with a catalyst;
isolating in an isolation step at least one, but not all, of the plurality of parallel flow paths to provide at least one isolated reactor train and remaining on-line reactor trains;
regenerating in a regeneration step the catalyst in the at least one reactor in the at least one isolated reactor train;
wherein during the regeneration step the feed material flows through the parallel flow paths in the remaining on-line reactor trains;
wherein the volume of feed material flowing through the plurality of parallel flow paths supplied from the battery limits and accepted for processing in the plant facility is approximately constant, varying by not more than 10%, before and during the isolation step.

2. The process according to claim 1 wherein the feed material is a mixture.

3. The process according to claim 1 or claim 2 wherein the feed material is a gas.

4. The process according to any one of claims 1 to 3 wherein the at least one reactor is a microstructure or microchannel reactor.

5. The process according to claim 4 wherein each reactor is a microchannel reactor.

6. The process according to any one of claims 1 to 5 wherein the number of reactor trains is at least two, or at least three, or at least four, or at least five.

7. The process according to any one of claims 1 to 6 wherein the plurality of reactor trains comprises at least two reactors, or at least three reactors, or at least four reactors.

8. The process according to any one of claims 1 to 7 wherein the at least one reactor is a Fischer-Tropsch reactor.

9. The process according to any one of claims 1 to 8 wherein the volume of the feed material flowing through the plurality of parallel flow paths before and during the isolation step does not vary by more than 7% or by more than 5%.

10. The process according to any one of claims 1 to 9 wherein the feed material comprises carbon monoxide and hydrogen.

11. The process according to any one of claims 1 to 10 wherein the feed material is a synthesis gas generated by gasifying biomass and/or municipal or solid waste.

12. The process according to any one of claims 1 to 11 wherein the regeneration of the catalyst takes place in situ in the isolated reactor train.

13. The process according to any one of claims 1 to 12 wherein the at least one isolated reactor train is offline for a period from about 3 days to about 14 days, or from about 4 days to about 12 days, or from about 5 days to about 10 days.

14. The process according to claim 13 wherein the at least one isolated reactor train is offline for a period of about 7 days.

15. The process according to any one of claims 1 to 14 wherein the catalyst is a metal-based catalyst, such as a cobalt or iron-containing catalyst.

16. The process according to claim 15 wherein the metal-based catalyst is a Fischer-Tropsch catalyst.

17. The process according to any one of claims 1 to 16 wherein the process is absent of flaring feedstock and/or turning down upstream units.

18. The process according to any one of claims 1 to 17 wherein the unit area of the plant facility is a Fischer-Tropsch island.

19. A plant facility for conducting during catalyst regeneration a chemical or biochemical process according to any one of claims 1 to 18.
